(19) United States
(12) Patent Application Publication
(10) Pub. No.: US 2020/0288740 A1
(43) Pub. Date: Sep. 17, 2020

(54) Light and Convenient Pneumatic Device for Preparing Tea Brick

(71) Applicant: Kam Fung MAK, Hong Kong (HK)

(72) Inventor: Kam Fung MAK, Hong Kong (HK)

(21) Appl. No.: 16/384,944

(22) Filed: Apr. 16, 2019

(30) Foreign Application Priority Data
Mar. 13, 2019 (CN) 201910186781.0

(51) Int. Cl. A23F 3/06; A23P 30/10; B30B 11/04; B30B 11/02

(52) U.S. Cl. CPC A23F 3/06; B30B 11/027; B30B 11/04; A23P 30/10

(57) ABSTRACT

The invention relates to a light and convenient pneumatic device for preparing tea brick includes a worktable, a supporting device arranged at the bottom of the worktable, a punching device arranged on the top of the supporting device and a limiting device arranged on the top of the worktable. The bottom of the worktable is provided with a rectangular receiving cavity with an opening upward. The supporting device includes a supporting component. The punching device includes a power component, a punching component and a waterproof component. The punching component includes a punching block. The light and convenient pneumatic device for preparing tea brick of the present invention includes a working compartment for holding tea leaves which is constituted by a limit block, a rectangular receiving cavity and a punching block. The punching block is used to punch. The tea leaves in the working compartment are extruded to tea bricks. The punched tea brick can be ejected together with the limiting blocks which facilitates to take the tea bricks out. The bottom of the worktable is provided with a water receiving tray which is used to receive the water during the extrusion process. The device is small and convenient which facilitates to process and prepare tea bricks on a small-scale.

### FIELD OF THE INVENTION

The invention relates to the technical field of tea processing, in particular to a light and convenient pneumatic device for preparing tea brick.

### BACKGROUND

Tea bricks are made from pressed tea leaves through mold pressing. In some areas, tea bricks are very popular, but in the production process of tea bricks, it is difficult to take the tea bricks out from the molds after the tea bricks are pressed in the molds and dried due to the fact that the molds generally have a closed receiving cavity. Or the tea bricks get loosen after being taken out. It is necessary to develop a small device for conveniently preparing tea bricks which can be easily taken out.

### SUMMARY OF THE INVENTION

The object of the present invention is to provide a light and convenient pneumatic device for preparing tea brick in view of the deficiencies of the prior art.

To solve the above problem, the present invention provides the following technical solution.

A light and convenient pneumatic device for preparing tea brick includes a worktable, a supporting device arranged at the bottom of the worktable, a punching device arranged on the top of the supporting device and a limiting device arranged on the top of the worktable. The bottom of the worktable is provided with a rectangular receiving cavity with an opening upward. The supporting device includes a supporting component fixedly disposed at the bottom of the worktable. The punching device includes a power component, a punching component and a waterproof component. The power component is fixedly disposed at the top of the supporting component. The punching component is fixedly disposed on an output end of the power component. The waterproof component is sleeved on an output end of the power component. The punching component includes a punching block, and the punching block is disposed in the rectangular receiving cavity. The bottom of the rectangular receiving cavity is provided with a protrusion for receiving the punching block. The limiting device includes a limiting component, and the limiting component includes a limiting block. The limiting block is arranged at the top of the rectangular receiving cavity. The punching block, the rectangular receiving cavity and the limiting block constitute a working compartment for preparing the tea brick.

Further, the power component includes a first cylinder and a cylinder shaft disposed at the top of the first cylinder. The first cylinder is fixedly disposed at the top of the supporting component, and the cylinder shaft is disposed at the top of the first cylinder. The punching block is fixedly arranged on the top of the cylinder shaft.

Further, the waterproof component includes a water receiving tray which is sleeved on the cylinder shaft and located at the top of the first cylinder.

Further, the supporting component includes four supporting legs and a supporting plate for fixing the first cylinder. The four supporting legs are distributed in a rectangular shape at the bottom of the worktable, and the supporting plate is horizontally and fixedly disposed at four supporting legs.

Further, the limiting component further includes a limiting cover. The limiting cover is disposed at the top of the worktable, and one end of the limiting cover is hinged with the worktable. One end of the limiting cover away from the hinge is provided with a plurality of buckles. The side wall of the worktable is provided with a plurality of blocks. Each of the buckles is engaged with each of the blocks.

Further, the limiting block and the punching block are rectangular plate-like structures of the same size and have the same cross-sectional size of the rectangular receiving cavity.

Further, the bottom of the limiting block is provided with stripes for punching and molding. The top of the punching block is provided with stripes for punching and molding.

The technical effect is as follows. A light and convenient pneumatic device for preparing tea brick of the present invention includes a working compartment for holding tea leaves which is constituted by a limit block, a rectangular receiving cavity and a punching block. The punching block is used to punch. The tea leaves in the working compartment are extruded to tea bricks. The punched tea brick can be ejected together with the limiting blocks which facilitates to take the tea bricks out. The bottom of the worktable is provided with a water receiving tray which is used to receive the water during the extrusion process. The device is small and convenient which facilitates to process and prepare tea bricks on a small-scale.

### BRIEF DESCRIPTION OF THE DRAWINGS

The invention is illustrated by the following figures and embodiments.

FIG. 1 shows a schematic diagram of three-dimension of a light and convenient pneumatic device for preparing tea brick in accordance with an example embodiment.

FIG. 2 shows a main view of a light and convenient pneumatic device for preparing tea brick in accordance with an example embodiment.

FIG. 3 shows a cross-sectional view of FIG. 2 along the line of A-A.

FIG. 4 shows a schematic diagram of three-dimension split structure of a light and convenient pneumatic device for preparing tea brick in accordance with an example embodiment.

The reference numbers of the figures are as follows:

1: worktable; 1a: rectangular receiving cavity; 1b: protrusion; 2: supporting device; 2a: supporting component; 2b: supporting leg; 2c: supporting plate; 3: punching device; 3a: power component; 3b: punching component; 3c: waterproof component; 3d: punching block; 3e: first cylinder; 3f: cylinder shaft; 3g: water receiving tray; 4: limiting device; 4a: limiting component; 4b: limiting block; 4c: limiting cover; 4d: buckle; 4e: block.

### DETAILED DESCRIPTION

The invention is illustrated in accordance with figures. The figures as simplified diagrams demonstrate the basic structures of the apparatus of embodiments of the invention. Thus, the invention is not limited to the figures.

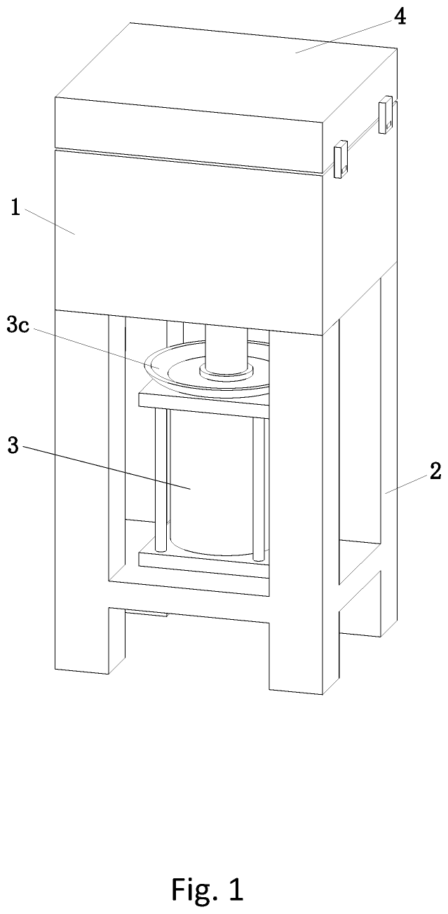

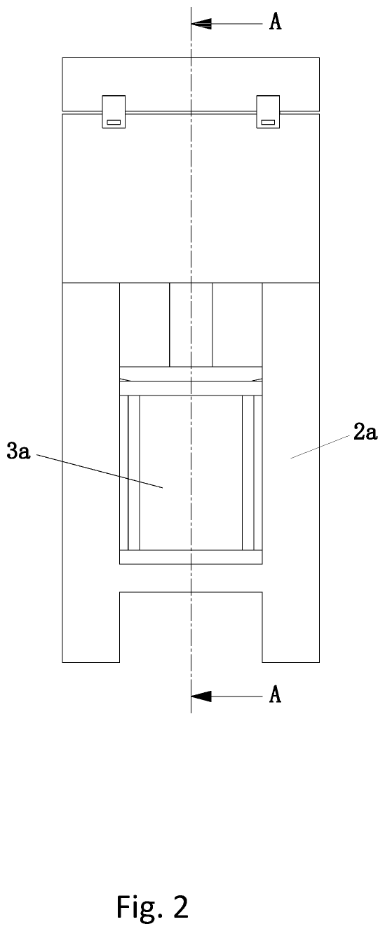

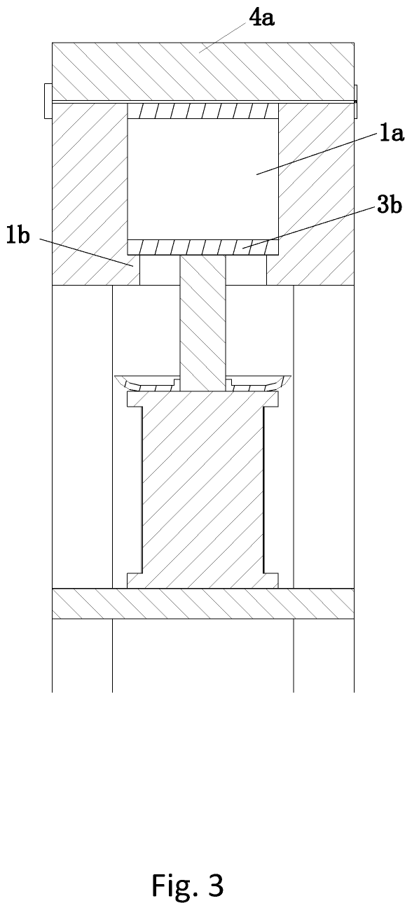

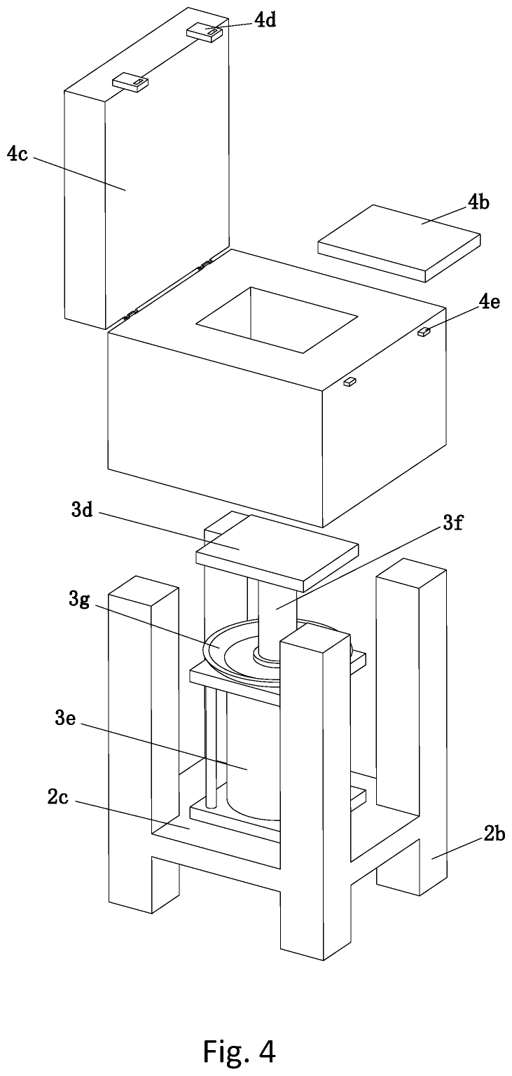

Referring to FIGS. 1-4, a light and convenient pneumatic device for preparing tea brick includes a worktable 1, a supporting device 2 arranged at the bottom of the worktable 1, a punching device 3 arranged on the top of the supporting device 2 and a limiting device 4 arranged on the top of the worktable 1. The bottom of the worktable 1 is provided with a rectangular receiving cavity 1a with an opening upward. The supporting device 2 includes a supporting component 2a fixedly disposed at the bottom of the worktable 1. The punching device 3 includes a power component 3a, a punching component 3b and a waterproof component 3c. The power component 3a is fixedly disposed at the top of the supporting component 2a. The punching component 3b is fixedly disposed on an output end of the power component 3a. The waterproof component 3c is sleeved on an output end of the power component 3a. The punching component 3b includes a punching block 3d, and the punching block 3d is disposed in the rectangular receiving cavity 1a. The bottom of the rectangular receiving cavity 1a is provided with a protrusion 1b for receiving the punching block 3d. The limiting device 4 includes a limiting component 4a, and the limiting component 4a includes a limiting block 4b. The limiting block 4b is arranged at the top of the rectangular receiving cavity 1a. The punching block 3d, the rectangular receiving cavity 1a and the limiting block 4b constitute a working compartment for preparing the tea brick. The rectangular receiving cavity 1a in the worktable 1 is a place where the tea brick is molded. On one hand, the supporting component 2a supports the worktable 1. On other hand, the supporting component 2a supports power component 3a. The power component 3a provides power in the vertical direction so that the punching block 3d can move upward and downward in the rectangular receiving cavity 1a. The limiting block 4b is used to restrict the position where the punching block 3d moves upward. During the upward punching of the punching block 3d, the steamed tea leaves are extruded. The waterproof component 3c is used for receiving the water during extrusion.

The power component 3a includes a first cylinder 3e and a cylinder shaft 3f disposed at the top of the first cylinder 3e. The first cylinder 3e is fixedly disposed at the top of the supporting component 2a, and the cylinder shaft 3f is disposed at the top of the first cylinder 3e. The punching block 3d is fixedly arranged on the top of the cylinder shaft 3f. The first cylinder 3e is opened. The first cylinder 3e drives the cylinder shaft 3f to move upward and meantime drives the punching block 3d to move upward.

The waterproof component 3c includes a water receiving tray 3g which is sleeved on the cylinder shaft 3f and located at the top of the first cylinder 3e. When the punching block 3d moves upward to extrude, the water in the streamed tea leaves is squeezed and the water receiving tray 3g is used to receive the water.

The supporting component 2a includes four supporting legs 2b and a supporting plate 2c for fixing the first cylinder 3e. The four supporting legs 2b are distributed in a rectangular shape at the bottom of the worktable 1, and the supporting plate 2c is horizontally and fixedly disposed at four supporting legs 2b. The four supporting legs 2b are mainly used to support the worktable 1. The supporting place 2c is mainly used to support and fix the first cylinder 3e.

The limiting component 4a further includes a limiting cover 4c. The limiting cover 4c is disposed at the top of the worktable 1, and one end of the limiting cover 4c is hinged with the worktable 1. One end of the limiting cover 4c away from the hinge is provided with a plurality of buckles 4d. The side wall of the worktable 1 is provided with a plurality of blocks 4e. Each of the buckles 4d is engaged with each of the blocks 4e. The appropriate amount of streamed tea leaves is placed in the rectangular receiving cavity 1a, and the limiting block 4b is closed. The limiting block 4c is then rotated to be closed and the buckle 4d is buckled.

The limiting block 4b and the punching block 3d are rectangular plate-like structures of the same size and have the same cross-sectional size of the rectangular receiving cavity 1a. The punching block 3d, the limiting block 3d and the rectangular receiving cavity 1a have the same cross section size, and the tea is extruded into tea bricks with rectangular shape during the extrusion.

The bottom of the limiting block 4b is provided with stripes for punching and molding. The top of the punching block 3d is provided with stripes for punching and molding. When the surface of the tea bricks needs molding to increase stripes, it can be achieved by changing the strips on the surface of the limiting block 4b and the punching block 3d.

The working principle is as follows. First, the limiting cover 4c is opened, and the limiting block 4b is taken out. The streamed tea leaves with an appropriate amount are placed in the rectangular receiving cavity 1a. The limiting block 4b is covered, and the limiting cover 4c is rotated and covered. The buckle 4d is buckled. The first cylinder 3e is opened, and the first cylinder 3e drives the cylinder shaft 3f to move upward and simultaneously drives the punching block 3d to move upward. Because the limiting block 4b is in a stationary state, the punching block 3d is moved upward and squeezed, and the water in the tea leaves is squeezed. The water receiving tray 3g is used for receiving the water to avoid contamination. When the extrusion and molding is completed, the first cylinder 3e is closed, and the limiting cover 4c is opened. At this time, the tea brick is made, but it is not easy to take out, and the first cylinder 3e can be opened again. The first cylinder 3e ejects the limiting block 4b and simultaneously ejects the tea bricks, at which time the substantially formed tea bricks are taken out.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. A light and convenient pneumatic device for preparing tea brick, comprising:
a worktable 1, a supporting device 2 arranged at the bottom of the worktable 1, a punching device 3 arranged on the top of the supporting device 2 and a limiting device 4 arranged on the top of the worktable 1; wherein the bottom of the worktable 1 is provided with a rectangular receiving cavity 1a with an opening upward; the supporting device 2 includes a supporting component 2a fixedly disposed at the bottom of the worktable 1; the punching device 3 includes a power component 3a, a punching component 3b and a waterproof component 3c; the power component 3a is fixedly disposed at the top of the supporting component 2a; the punching component 3b is fixedly disposed on an output end of the power component 3a; the waterproof component 3c is sleeved on an output end of the power component 3a; the punching component 3b includes a punching block 3d, and the punching block 3d is disposed in the rectangular receiving cavity 1a; the bottom of the rectangular receiving cavity 1a is provided with a protrusion 1b for receiving the punching block 3d; the limiting device 4 includes a limiting component 4a, and the limiting component 4a includes a limiting block 4b; the limiting block 4b is arranged at the top of the rectangular receiving cavity 1a; the punching block 3d, the rectangular receiving cavity 1a and the limiting block 4b constitute a working compartment for preparing the tea brick,
wherein the power component 3a includes a first cylinder 3e and a cylinder shaft 3f disposed at the top of the first cylinder 3e; the first cylinder 3e is fixedly disposed at the top of the supporting component 2a, and the cylinder shaft 3f is disposed at the top of the first cylinder 3e; the punching block 3d is fixedly arranged on the top of the cylinder shaft 3f; the limiting component 4a further includes a limiting cover 4c; the limiting cover 4c is disposed at the top of the worktable 1, and one end of the limiting cover 4c is hinged with the worktable 1; one end of the limiting cover 4c away from the hinge is provided with a plurality of buckles 4d; the side wall of the worktable 1 is provided with a plurality of blocks 4e; each of the buckles 4d is engaged with each of the blocks 4e.

2. The light and convenient pneumatic device for preparing tea brick of claim 1, wherein the waterproof component 3c includes a water receiving tray 3g which is sleeved on the cylinder shaft 3f and located at the top of the first cylinder 3e.

3. The light and convenient pneumatic device for preparing tea brick of claim 1, wherein the supporting component 2a includes four supporting legs 2b and a supporting plate 2c for fixing the first cylinder 3e; the four supporting legs 2b are distributed in a rectangular shape at the bottom of the worktable 1, and the supporting plate 2c is horizontally and fixedly disposed at four supporting legs 2b.

4. The light and convenient pneumatic device for preparing tea brick of claim 1, wherein the limiting block 4b and the punching block 3d are rectangular plate-like structures of the same size and have the same cross-sectional size of the rectangular receiving cavity 1a.

5. The light and convenient pneumatic device for preparing tea brick of claim 4, wherein the bottom of the limiting block 4b is provided with stripes for punching and molding; the top of the punching block 3d is provided with stripes for punching and molding.
